(19) United States
(12) Patent Application Publication
(10) Pub. No.: US 2004/0046618 A1
(43) Pub. Date: Mar. 11, 2004

(54) Miniaturized balun

(76) Inventors: Jyh-Wen Sheen, Hsinchu (TW); Chin-Feng Cheng, Chu Pei City (TW)

Correspondence Address: VENABLE, BAETJER, HOWARD AND CIVILETTI, LLP, P.O. BOX 34385, WASHINGTON, DC, 20043-9998, US

(21) Appl. No.: 10/237,857

(22) Filed: Sep. 10, 2002

(51) Int. Cl. H01P 5/10

(52) U.S. Cl. 333/26

(57) ABSTRACT

A miniaturized balun with a four-wire system may be constructed with laminated construct for coupling from an unbalanced transmission line to a balanced transmission line, wherein unbalanced signals are input from a first pair of middle substrates, whilst balanced signal outputs are set up on a second pair of substrates disposed above and below the first pair. The use of such laminated circuit board makes it possible to reduce the overall size of the balanced converter considerably and ideal to implement the converter circuit on an integrated device.

### BACKGROUND OF THE INVENTION

1. Field of the Invention

The present invention relates to a balun (balanced to unbalanced transformer) with four-wire system for coupling an unbalanced transmission line to a balanced transmission line, the circuit of which is constructed on laminated substrates, so that the overall size of the balanced converter can be effectively reduced for implementation on an integrated device.

2. Description of Related Arts

FIG. 6 shows the structure of a currently available balanced converter (2), which is used for coupling an unbalanced signal transmission line to a balanced signal transmission line. The balanced converter (2) is based on two parallel wires, wherein the first wire of the twin-wire system includes two line segments (24a) (24b), having one end set up for unbalanced signal input (32g). The second wire of the twin-wire system also includes two line segments (26) (28), having one end of each connected to ground, whilst the other ends are respectively connected to balanced signal outputs (32e) (32f). The line segments (26) (28) of the first wire respectively correspond to the line segments (24a) (24b) of the second wire.

FIG. 7 is an exploded view of the balun mentioned above, wherein the top substrate (290) and the bottom substrate (294) each has a metal plate (30) on the main surface for preventing magnetic flux from escaping from the circuit board. The first wire (24a) (24b) and the second wire (26) (28) of the twin-wire system as shown in FIG. 6 are disposed on the third and fourth substrates (292) (293) respectively, wherein the two segments (24a) (24b) of the first wire correspond to the two segments (26) (28) of the second wire.

Although the balun (2) is implemented on an integrated device in an attempt to reduce the size of printed circuit board thereof, an external capacitor C with high capacitance is still needed. FIG. 8 shows the balanced signal outputs (32e) (32f) of the above-mentioned laminated balanced converter (2) being connected to a DC bias voltage circuit (35). Since the balanced signal outputs (32e) (32f) are connected to ground, the DC bias voltage circuit could be shorted to ground. That is the reason that a capacitor C with high capacitance is used between the balanced signal outputs (32e) (32f) and the ground terminal.

From the foregoing, although the conventional balun is constructed with laminated substrates to reduce the size of the converter, an external capacitor with high capacitance value would still be needed in the circuit of a currently used balun thus hampering the efforts in the miniaturization of related circuit boards.

### SUMMARY OF THE INVENTION

The main object of the present invention is to provide a miniaturized version of a balun having high frequency grounding capability, but without using any external capacitor of high capacitance value for the DC bias voltage circuit. Such a balun supporting four parallel wires can be constructed on a laminated circuit board, wherein conductive strips for accepting unbalanced signals are set up on the first pair of substrates interconnected by metal connecting studs, and conductive strips for outputting balanced signals are respectively formed on the second pair of substrates disposed above and below the first pair of substrates. The use of laminated circuit board on such converter device allows the size of the circuit board to be effectively reduced for implementation on an integrated device.

The secondary object of the invention is to provide a metal plate substrate disposed in between a pair of opposing substrates having grounded electrodes, forming a ground capacitor through the metal plate and the ground electrodes, wherein the metal plate is connected to a balanced signal output through a metal connecting stud. Since the capacitor is formed with a laminated substrate, the size of the converter can be greatly reduced, and no external capacitor of high capacitance value is needed for the DC bias voltage circuit.

The features and structure of the present invention will be more clearly understood when taken in conjunction with the accompanying figures.

### BRIEF DESCRIPTION OF THE DRAWINGS

FIG. 1 is a schematic of the balun of the first embodiment with a four-wire transmission line;

FIG. 2 is a schematic of the balun of the second embodiment with a four-wire transmission line;

FIG. 3 is an exploded diagram of the laminated circuit board for the first embodiment;

FIG. 4 is an exploded diagram of the laminated circuit board for the second embodiment;

FIG. 5 is an exploded diagram of the laminated circuit board for the third embodiment;

FIG. 6 is a schematic of a conventional balun with two-wire transmission line;

FIG. 7 is an exploded diagram of the laminated circuit board in a conventional balun; and

FIG. 8 is the operation circuit for a conventional balun.

### DETAILED DESCRIPTION OF THE PREFERRED EMBODIMENT

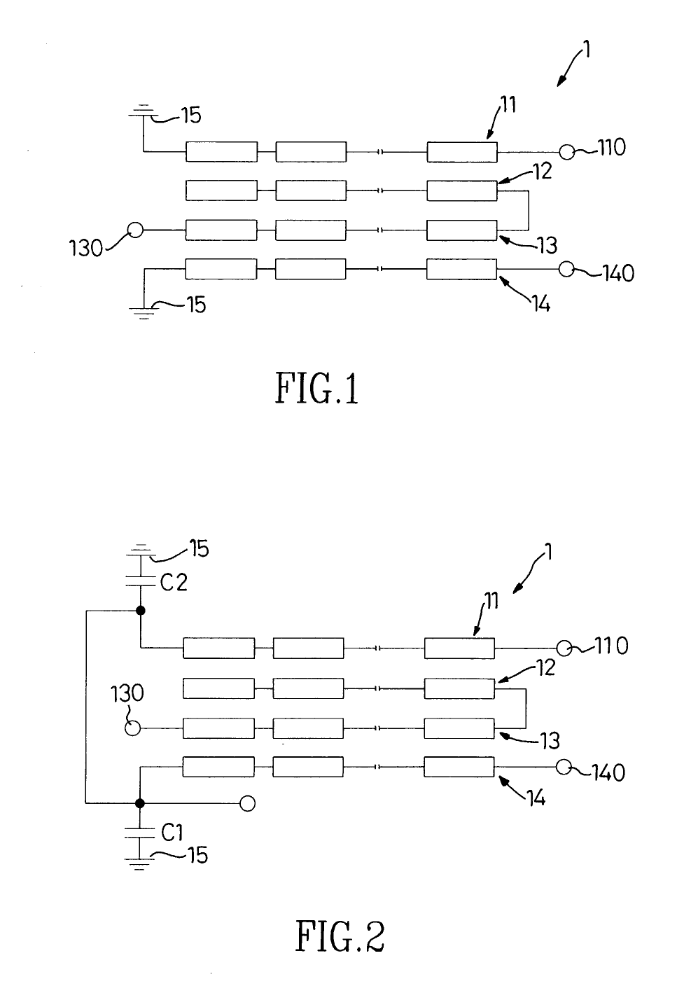

The present invention is about the formation of a miniaturized version balun with internally created grounded capacitors. FIG. 1 shows a balun of the first embodiment coupling an unbalanced transmission line to a balanced transmission line. A balun (1) may be constructed with a four-wire system (11-14), wherein one end of a second (12) and third conductive strips (13) are connected in series, wherein another end of the third conductive strip (13) is set up for unbalanced signal input (130), whilst one ends of a first (11) and fourth conductive strips (14) are respectively connected to ground, whilst the other ends are set up for balanced signal output (110) (140) from the converter (1).

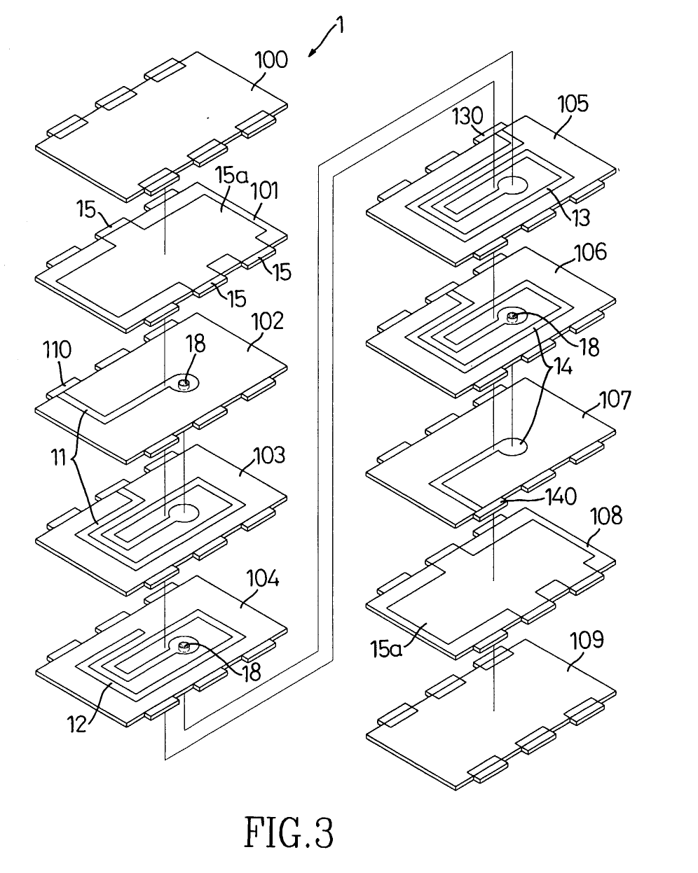

FIG. 3 is an exploded diagram of the laminated circuit board for the first embodiment of the invention, wherein the converter (1) is formed with ten substrates (100-109) superimposed on one another, wherein the top-most substrate (100) and the bottom-most substrate (109) are used for electrical insulation; the fourth (103) and seventh substrate (106) are used for setting up a first (11) and fourth conductive strips (14) as shown in FIG. 1; the third (102) and eighth substrate (107) respectively form the line segments of the first (11) and fourth conductive strips (14) respectively and connect to the edge terminals of the third and eighth substrates (102) respectively, and further connected to the fourth substrate (103) and the seventh substrate (106) respectively through metal connecting studs (18). Therefore the first conductive strip (11) and the fourth conductive strip (14) based on the layout mentioned above are set up for balanced signal outputs (110) (140) through the edge terminals on substrates (102) and (107) respectively.

The fifth substrate and sixth substrate (104) (105) are used respectively for setting up the second (12) and third conductive strips (13). Since the second and third conductive strips (12) (13) are symmetric, the ends of the fifth (104) and sixth substrates (105) are coupled to each other through metal connecting studs (18), allowing the third conductive strip (13) to be set up for unbalanced signal input (130) through an edge terminal on the sixth substrate (105).

A ground electrode (15a) is respectively formed on the second (101) and ninth substrate (108), such that the ground electrodes (15a) are connected to the edge terminals of the second and ninth substrates (101) (108) to form ground electrodes (15).

FIG. 2, a schematic of the balanced converter for the second embodiment, is based on a four-wire system like that shown in FIG. 1, except that one end of the first and fourth conductive strips (11) (14) connecting to ground are respectively coupled with capacitors (C1) (C2), which are designed to prevent shorting of the DC bias voltage circuit to ground.

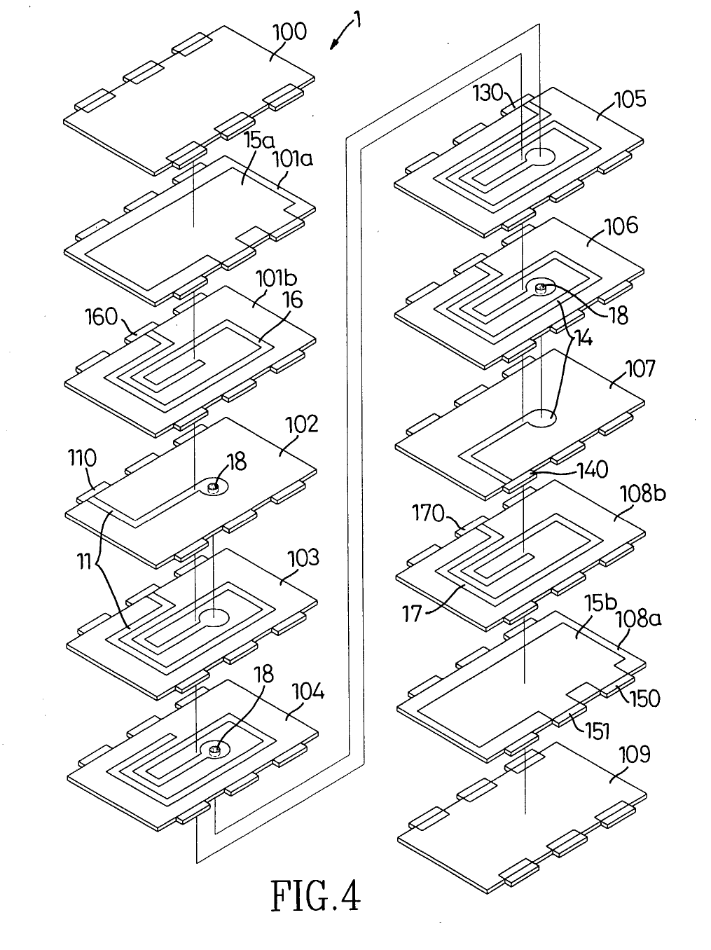

FIG. 4 is an exploded diagram of the laminated circuit board of the second embodiment, wherein the converter (1) is formed with twelve substrates (100), (101a˜101b), (102˜107), (108a˜108b), and (109). The circuit layout for the fourth to ninth substrates (102˜107), the first and second substrates (100) (101a), and the eleventh and twelfth substrates (108a) (109) are similar to those laminated substrates shown in FIG. 3, except the formation of spiral metal strips (16) (17) on the third and tenth substrates (101b) (108b), wherein one end of the spiral metal strip (16) of the third substrate (101b) on an edge terminal is set up for input from the DC bias voltage circuit (160), which is then connected to substrates (102) (103) forming the first conductive strip (11). For the same reason, one end of the metal strip (17) of the tenth substrate (108b) on an edge terminal is set up for input from the DC bias voltage circuit (170), which is then connected to the fourth conductive strip (14), such that two metal plate substrates (101b) (108b) are formed above and below the substrates forming the first and fourth conductive strips (11) (14). Therefore, substrates (101b) (108b) and substrates (101a) (108a) forming ground electrodes (15a) (15b) together form capacitors (C1) (C2) as shown in FIG. 2.

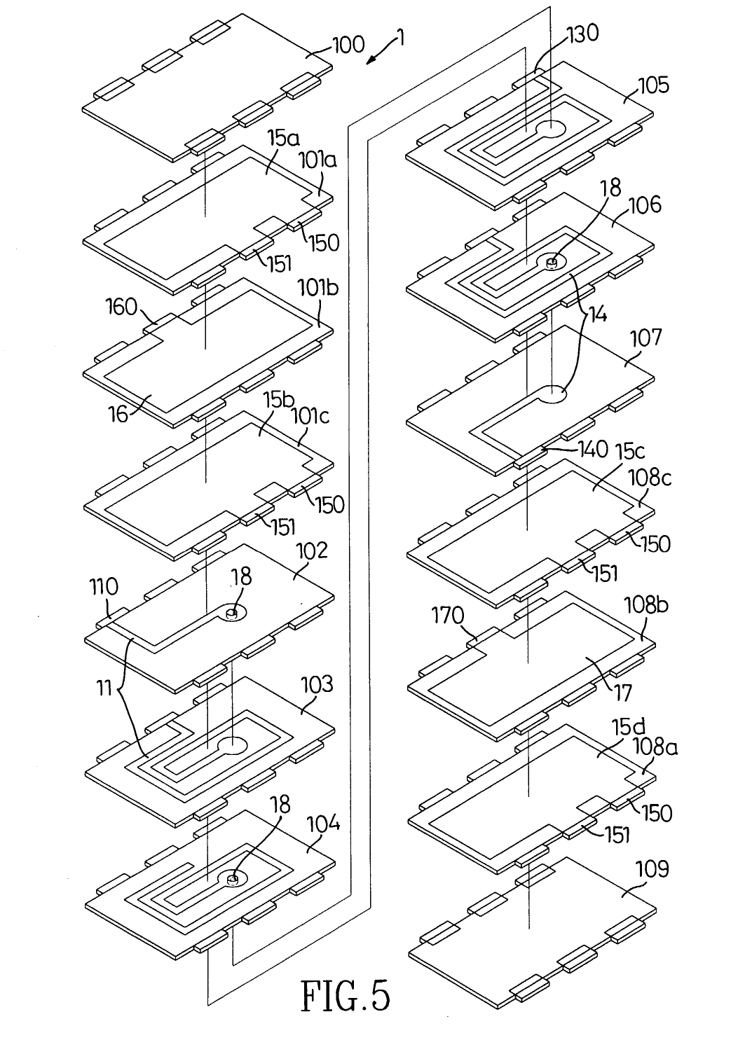

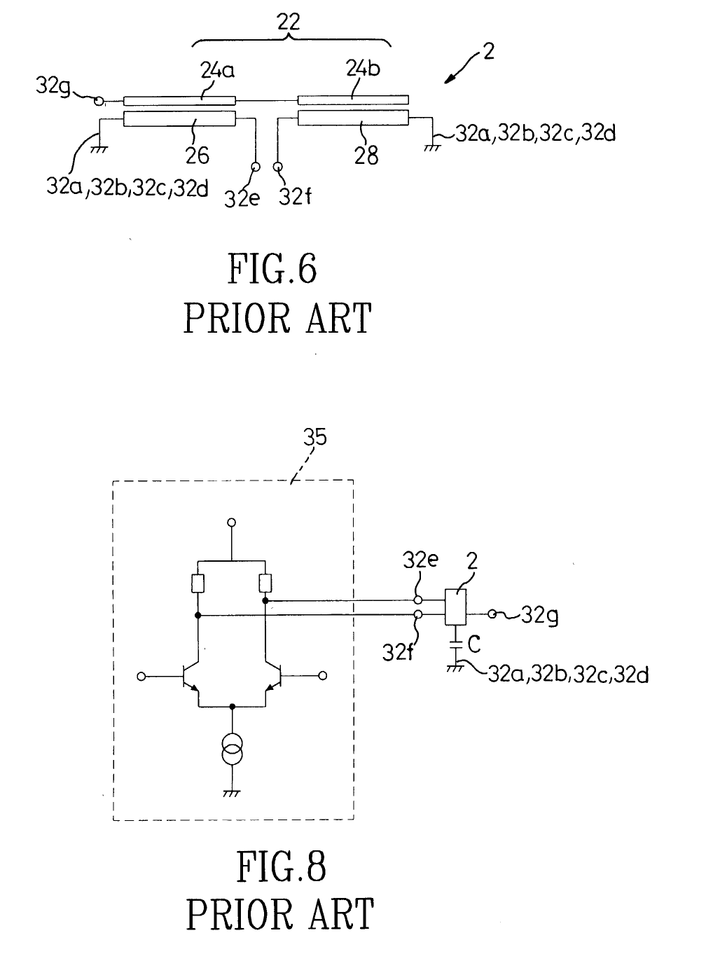

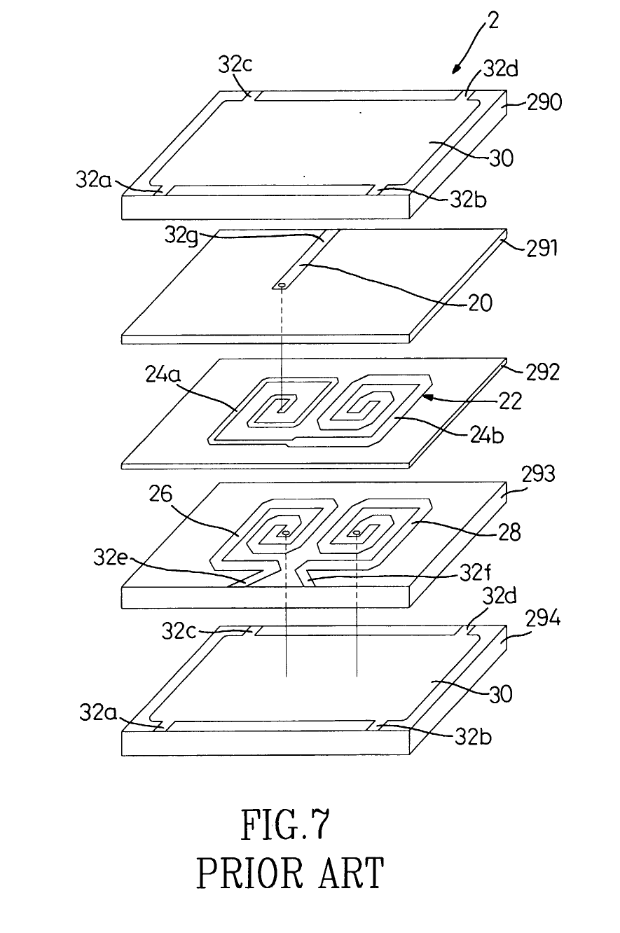

FIG. 5 is an exploded diagram of the laminated circuit boards of the third embodiment; which is just another example like that shown in FIG. 2. The current embodiment of the balun is formed with fourteen substrates (100), (101a˜101c), (102˜107), (108a˜108c), and (109); wherein the circuit layouts of the fifth to tenth substrates (102˜107), the first to third substrates (100) (101a) (101b), and the twelfth to fourteenth substrates (108a) (108b) (109) are similar to those shown in FIG. 4. The only difference lies in the formation of ground electrodes on substrates (101c) (108c). Metal plates (16) (17) are created on the two substrates (101c) (108c) forming ground capacitors (C1) (C2) together with substrates (101a) (108a) having ground electrodes. The metal plate (15a) of the second substrate (101a) is connected to two adjacent edge terminals forming ground terminals (150) (151). The metal plate (16) of the third substrate (101b) is connected to an edge terminal thereof for setting up the DC bias voltage input (160). The plate electrode (15d) of the thirteenth substrate (108a) is connected to adjacent edge terminals thereof for setting up the ground terminals (150) (151). The metal plate (17) of the twelfth substrate (108b) is connected to an edge terminal thereof for setting up the DC bias voltage input (170). The metal plates (16) (17) disposed above and below the DC bias voltage input terminal (170) are formed between two sets of ground electrodes (15a) (15b) and (15c) (15d), together forming capacitors (C1) (C2) as shown in FIG. 2.

The construct of the four-wire system and laminated substrates allows the size of the circuit board to be greatly reduced, and the use of opposing metal plates and ground electrodes to form capacitors obviates the use of external capacitors, thereby the component count is reduced, and so is the overall size of the circuit board.

The foregoing description of the preferred embodiments of the present invention is intended to be illustrative only and, under no circumstances, should the scope of the present invention be so restricted.

What is claimed is:

1. A miniaturized balun, comprising four parallel conductive strips, wherein the second and third conductive strips are connected in series; and one end of the third conductive strip is set up for unbalanced signal input; and one ends of the first and fourth conductive strips are connected to ground, whilst opposite ends are set up for balanced signal output from the balun.

2. The miniaturized balun as claimed in claim 1, wherein the first and fourth conductive strips are connected in series and each is coupled with a capacitor on the ground terminal.

3. The miniaturized balun as claimed in claim 2, wherein a capacitor is formed by setting up of a metal plate in between two opposing substrates.

4. The miniaturized balun as claimed in claim 1, the second and third conductive strips are formed on two middle substrates in spiral-shaped strip line, being electrically connected to each other through conductors.

5. The miniaturized balun as claimed in claim 4, the first and fourth conductive strips are each formed on a substrate above and below the substrates forming the second and third conductive strips for coupling an unbalanced transmission line to a balanced transmission line.

6. The miniaturized balun as claimed in claim 5, the substrates forming the first and fourth conductive strips have a substrate disposed above and below the substrates having a metal plate on the surface for grounding, thus the two grounded substrates are respectively connected to the first and fourth conductive strips through conductors.

7. The miniaturized balun as claimed in claim 5, wherein the substrates forming the first and fourth conductive strips have a substrate disposed above and below the substrates forming a spiral metal strip, together with the opposing substrates having ground electrodes thus forming two ground capacitors; and the two substrates forming spiral metal strips are electrically connected to each other, and to the first and fourth conductive strips through conductors.

8. The miniaturized balun as claimed in claim 5, wherein the substrate forming the first conductive strip has a substrate having metal plate and a substrate having a ground electrode disposed above the substrate in that order, which together forms a grounded capacitor; and the substrate having a metal plate and the substrate forming the first conductive strip are connected to each other through conductors.

9. The miniaturized balun as claimed in claim 5, wherein the substrate forming the fourth conductive strip has a substrate having a metal plate and a substrate having a ground electrode disposed underneath the substrate in that order, which together forms a grounded capacitor; and the substrate having a metal plate and the substrate forming the fourth conductive strip are connected to each other through conductors.

10. The miniaturized balun as claimed in claim 8, wherein the substrate forming the fourth conductive strip has a substrates having a metal plate and a substrate having a ground electrode disposed underneath the substrate in that order, which together forms a ground capacitor, and the substrate having a plate metal and the substrate forming the fourth conductive strip are connected to each other through conductors

11. The miniaturized balun as claimed in claim 5, wherein the first and fourth conductive strips are spiral shaped and formed on corresponding substrates.

12. The miniaturized balun as claimed in claim 4, wherein the conductor used to connect two opposing substrates can be a metal connecting stud.

13. The miniaturized balun as claimed in claim 6, wherein the conductor used to connect two opposing substrates can be a metal connecting stud.
